(19) United States
(12) Patent Application Publication
(10) Pub. No.: US 2008/0104641 A1
(43) Pub. Date: May 1, 2008

(54) BROADCAST TERMINAL AND METHOD OF REPRODUCING BROADCAST DATA

(75) Inventor: Soojin Jeon, Seongnam (KR)

Correspondence Address: LEE, HONG, DEGERMAN, KANG & SCHMADEKA, 660 S. FIGUEROA STREET, Suite 2300, LOS ANGELES, CA, 90017, US

(73) Assignee: LG Electronics Inc.

(21) Appl. No.: 11/874,872

(22) Filed: Oct. 18, 2007

(30) Foreign Application Priority Data
Oct. 19, 2006 (KR) 10-2006-0101832

(51) Int. Cl. H04N 7/16; H04N 5/50

(52) U.S. Cl. 725/62; 348/731; 348/E05.097

(57) ABSTRACT

A broadcast terminal and method for reproducing broadcast data includes reproducing broadcast data received from a first broadcast channel, switching from the first broadcast channel to a second broadcast channel, storing the data received from the first broadcast channel in a storage medium, and reproducing second broadcast data received from the selected second broadcast channel. The stored broadcast data will be reproduced when the first broadcast channel is again selected, and the reproduction of the stored data will begin at the start of the stored data or at some other point determined by a user. In this manner, a user can view all the broadcast data received from the first broadcast channel including the data received while viewing another channel.

This application claims the benefit of Korean Patent Application No. 10-2006-0101832 filed on Oct. 19, 2006, which is hereby incorporated by reference for all purposes as if fully set forth herein.

### FIELD OF THE INVENTION

The invention relates generally to a mobile communication terminal, and more particularly to a terminal for receiving multimedia broadcast channels wherein data from a first broadcast channel is stored while data from a second broadcast channel is being viewed.

### DESCRIPTION OF THE RELATED ART

With the recent development of broadcasting technologies, a broadcast can be viewed not only at fixed places and fixed times but also while moving or at a desired time. In particular, DMB (Digital Multimedia Broadcasting) services have been provided in Korea since 2005, and it is expected that mobile digital broadcasting services will be provided globally in the future. Digital broadcasting standards have been proposed and adopted for mobile communication terminals.

Presently, only a single broadcast channel may be viewed at one time. If another broadcast channel is to be viewed, the terminal is switched to a second channel and the data from the first broadcast channel is no longer viewed. It is advantageous if data from the first channel can be stored for later viewing when the second channel is being viewed.

### SUMMARY

Accordingly, the present invention has been made to address the problems of the prior art, and an object of the present invention continue to receive and store broadcast media from a first broadcast channel while reproducing or playing the broadcast media from a second broadcast channel, and to reproduce the stored broadcast media when switching back to the first broadcast channel.

A method of reproducing broadcast data in a broadcast terminal comprises reproducing first broadcast data received from a first broadcast channel, switching from the first broadcast channel to a second broadcast channel, wherein the second broadcast channel is selected from a plurality of second broadcast channels, storing the first broadcast data in a storage medium, and reproducing second broadcast data received from the selected second broadcast channel.

When switching back to the first broadcast channel, the stored first broadcast data is reproduced, and subsequently deleted from storage. The reproduction of the stored broadcast data may begin from the point at which the broadcast data was stored, or at any subsequent point in time as determined by a user.

In another embodiment of the present invention, a broadcast terminal comprises a memory for storing broadcast data, a broadcasting reception module configured to receive broadcast data from a first broadcast channel and a second broadcast channel selected from a plurality of second broadcast channels, and a controller coupled with the broadcast reception module. The controller is configured to reproduce the first broadcast data received from a first broadcast channel, to switch from the first broadcast channel to the selected broadcast channel, to store the first broadcast data in a storage medium, and to reproduce second broadcast data received from the selected second broadcast channel.

The controller is further configured to switch from the selected second channel to the first channel, and to reproduce the stored first broadcast data while continuing to store the received first broadcast data, and to delete the reproduced stored first broadcast data after reproducing the stored first broadcast data.

### BRIEF DESCRIPTION OF THE DRAWINGS

The invention will be described in detail with reference to the following drawings in which like numerals refer to like elements. The accompany drawings, which are included to provide a further understanding of the invention and are incorporated in and constitute a part of this specification, illustrate embodiments of the invention and together with the description serve to explain the principles of the invention.

FIG. 1 is a block diagram of a mobile terminal according to an embodiment of the present invention.

FIG. 2 is a block diagram showing the flow of broadcasting signals in the terminal according to one embodiment.

FIG. 3 illustrates the time necessary to effect switching from the first broadcast channel to the second broadcast channel.

FIG. 4 illustrates the starting point for the reproduction of the stored first broadcast data.

FIG. 5 is a flowchart illustrating a method of playing broadcast data in a mobile terminal according to one embodiment of the present invention.

FIG. 6 illustrates the time-line for storing broadcast data from the first broadcast channel, switching to and reproducing broadcast data from the second broadcast channel, and switching back to the first broadcast channel and reproducing the stored first broadcast data.

FIG. 7 illustrates an embodiment in which more than one second channel are sequentially viewed while continuing to store broadcast data from the first broadcast channel.

### DETAILED DESCRIPTION OF EMBODIMENTS

Embodiments of the present invention will be described in a more detailed manner with reference to the drawings. Reference will now be made in detail to embodiments of the present invention, examples of which are illustrated in the accompanying drawings.

Examples of broadcasting standards include European DAB (Digital Audio Broadcasting) based on Eureka-147 [ETSI EN 300 401], DVB-H (Digital Video Broadcasting-Handheld), Media FLO (Forward Link Only) developed by Qualcomm, Korean DMB (Digital Multimedia Broadcasting), and Japanese ISDB-T (Integrated Service Digital Broadcasting-Terrestrial). Korean DMB is divided into T-DMB (Terrestrial-Digital Multimedia Broadcasting) based on Eureka-147 and S-DMB (Satellite-Digital Multimedia Broadcasting) using Satellites. Details of respective broadcasting standards are omitted in this specification.

Although the above are examples of mobile digital broadcasting, the present invention is not limited to the broadcasting standards mentioned here. That is, broadcasting standards which may be implemented include terrestrial broadcasting standards such as 8-VSB developed by Zenith and embodies American ATSC digital TV standard, or European DVB-T(Digital Broadcasting-Terrestrial).

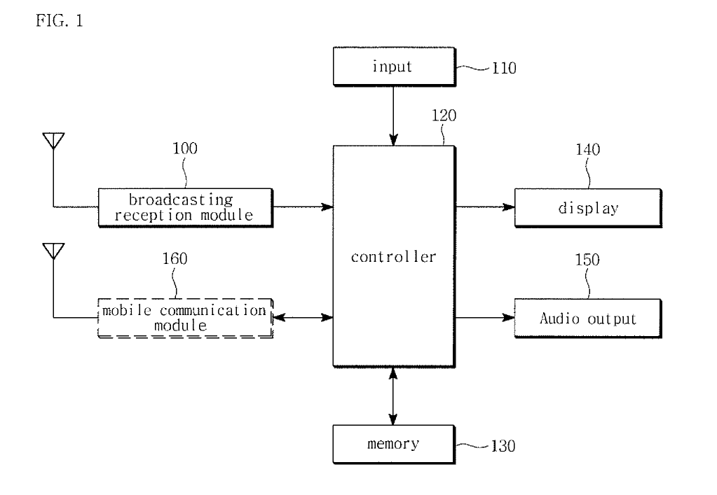

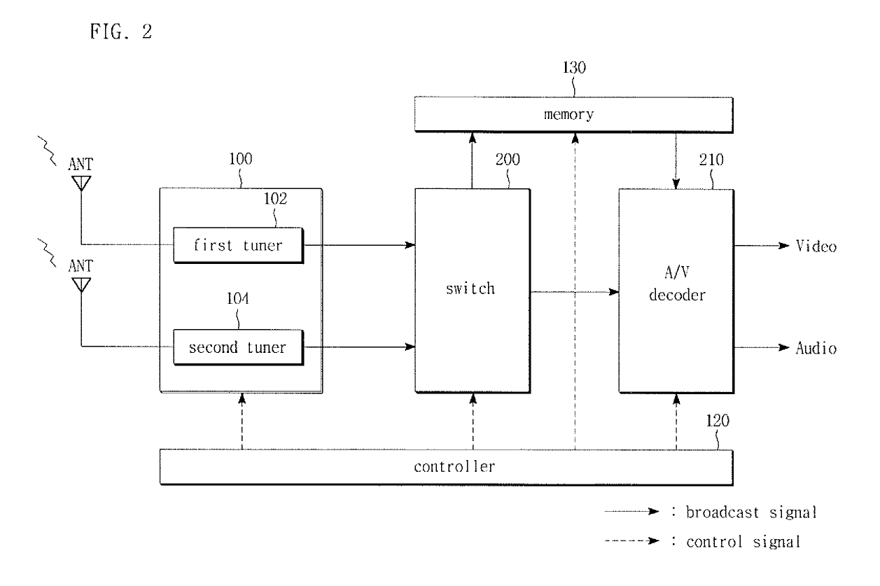

FIG. 1 is a schematic block diagram illustrating the construction of a mobile terminal according to an embodiment of the present invention. FIG. 2 is a block diagram illustrating the flow of broadcast signals in the terminal according to an embodiment of the present invention.

Referring to FIGS. 1 and 2, the terminal according to an embodiment of the present invention is described in detail below. The terminal according to one embodiment includes a broadcast reception module 100, an input 110, a controller 120, a memory 130, a display 140, and audio output 150, a switch 200 and Audio/Video (A/V) decoder 210.

The broadcast reception module 100 is a wireless communication device for receiving broadcast signals from a network. The broadcast reception module 100 simultaneously can receive signals from at least two channels, demodulates, and outputs the broadcast signals. Therefore, the broadcast reception module 100 may include at least two tuners 102 and 104. The broadcast reception module 100 can simultaneously receive two broadcast signals using the first and second tuners 102 and 104.

The input 110 is a device for receiving information and commands, and may be a keypad having various numeric and direction keys, or a touch input device. The memory 130 stores programs for controlling the operation of the terminal and stores broadcast data to be reproduced for display on the terminal. The display 140 displays broadcast data and various information of the terminal.

The mobile communication module 160 is a wireless transceiver for sending and receiving data to and from a communication network. The mobile communication module 160 is required when a communication function is to be performed simultaneously with the broadcast receiving function of the present invention.

The switch 200 routes the broadcast signals received from the first tuner 102 and the second tuner 104 to the memory 130 and the A/V decoder 210 according to a control signal from the controller 120.

The A/V decoder 210 decodes the broadcast signals routed from the switch 200 and provides the decoded signals to the display 140 and the audio output 150.

The first tuner 102 receives data from a first broadcast channel, and the second tuner 104 receives data from a second broadcast channel. The first and second broadcast channels may be based on the same broadcast standard, and may be channels for the transmission of different multimedia content. The channel transmitting multimedia content may be a video channel, an audio channel, or a data channel. For example, the first channel is an video channel, and the second channel is an audio channel.

Furthermore, the first and second broadcast channels may use different broadcasting standards. For example, the first broadcast channel may be based on T-DMB, and the second broadcast channel may be based on S-DMB.

The controller 120 reproduces the second broadcast data received from the second broadcast channel while storing the received first broadcast data in the memory 130 when the channel is switched to the second broadcast channel.

For example, before switching to the second broadcast channel, the controller 120 controls the switch 200 to deliver the first broadcast data from the first tuner 102 to the A/V decoder 210. The A/V decoder 210 decodes the first broadcast data received from the switch 200 and outputs the decoded data.

The controller 120 controls the switch 200 according to a command signal to store the first broadcast data in the memory 130. The controller 120 also activates the second tuner 104 according to the command signal. The second tuner 104 receives the second broadcast data from the second broadcast channel and provides the second broadcast data to the switch 200. The switch 200 provides the second broadcast data to the A/V decoder 210. The A/V decoder 210 decodes and outputs the second broadcast data.

A time delay occurs for the controller 120 to initially receive and reproduce the second broadcast data after switching to the second broadcast channel. The controller 120 activates the second tuner 104. The second broadcast data received from the activated second tuner 104 is routed through the switch 200 to the A/V decoder 210. Switching from the first broadcast channel to the second broadcast channel takes about 1-3 seconds to complete. The time to complete the switching of broadcast channels may differ depending on the performance or state of the terminal, or the type of broadcast standard

The time the broadcast data is initially stored may be when the channel switching is started or is completed. For example, the time when channel switching is started may be when the input unit 110 is manipulated to change channels. The time when channel switching is completed may be when the second broadcast channel is reproduced on the display 140.

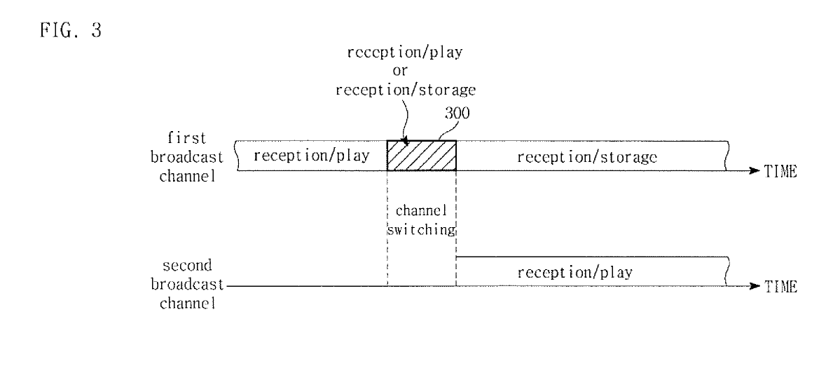

FIG. 3 shows the range of the starting point for the reproduction of the first broadcast data. As illustrated by FIG. 3, the time 300 for switching from the first broadcast channel to the second broadcast channel is needed. The time point at which the first broadcast data is initially stored in the memory 130 may be any time point within the interval indicated by reference number 300.

The controller 120 reproduces the received first broadcast data until the second broadcast data is initially reproduced.

The controller 120 can reproduce the stored first broadcast data from a specific point while continuing to store the first broadcast data during switching to the second broadcast channel.

For example, the controller 120 receives a command to switch from the second broadcast channel to the first broadcast channel while displaying the second broadcast channel. The controller 120 stores the first broadcast data in the memory 130 from the A/V decoder 210 according to the command signal directing the return to the first broadcast channel. The first broadcast data which is currently received through the first tuner 102 continues to be stored in the memory 130 from the switch 200.

Therefore, there is a time delay between when the first broadcast data is stored in the memory 130 and when the first broadcast data is provided from the memory 130 via the A/V decoder 210.

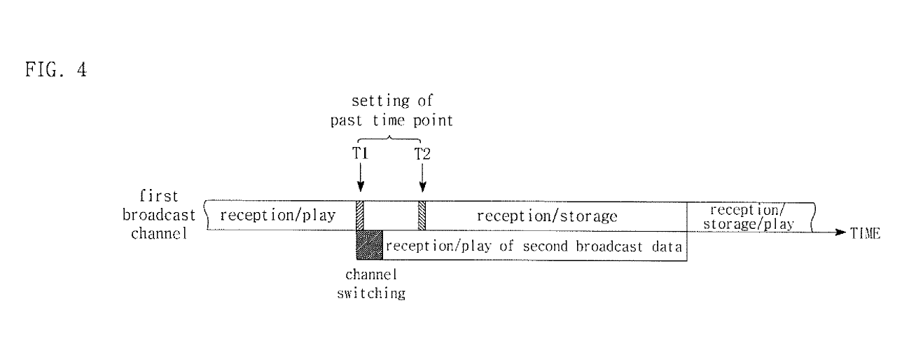

The starting point refers to a point in time at which the storage of the broadcast data from the received channel begins. FIG. 4 shows the storage initiation time. The storage initiation time may be set or changed by the user. For example, the starting point may be the time at which channel switching is initiated as shown by point T1 on FIG. 4. The starting point may also be set to any point between the time at which the first broadcast data is initially stored and the time of switching back to the first broadcast channel as by point T2 on FIG. 4. Furthermore, the user may change the starting point while reproducing the first broadcast data stored in the memory 130

The first broadcast channel cannot be viewed while viewing broadcasts of the second broadcast channel. When switching back to the first broadcast channel while viewing the second broadcast channel, the first broadcast data stored in the memory 130 may be reproduced so that viewing the content of the first broadcast channel is not interrupted.

The controller 120 deletes the first broadcast data as it is reproduced from the memory 130 to the A/V decoder 210. Generally, memory included in a terminal has limited capacity and the first broadcast data cannot be stored without limitation. In particular, this limitation is more serious in portable or mobile broadcast terminals. Therefore, the broadcast data is deleted from the memory 130 after being reproduced.

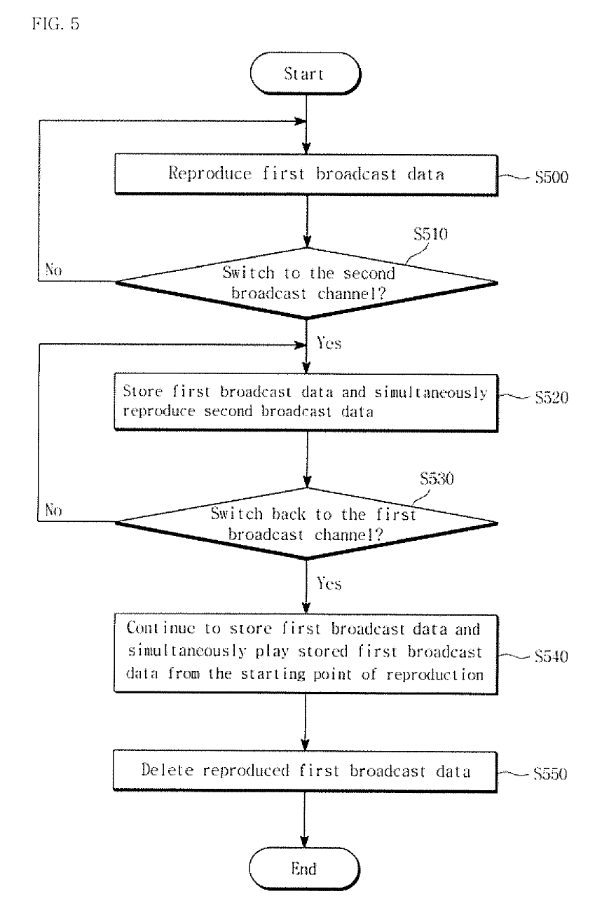

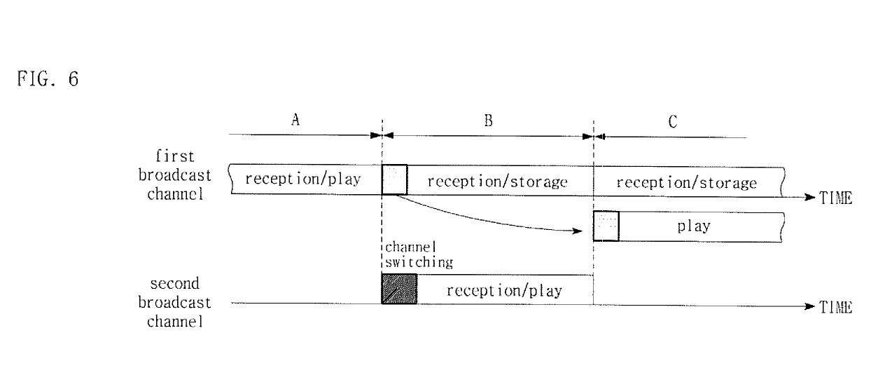

FIG. 5 shows a method of reproducing broadcast data in a broadcast terminal according to one embodiment. FIG. 6 illustrates the time-line of the method shown in FIG. 5. Referring to FIGS. 5 and 6, an example of the method for reproducing broadcast data of the broadcast terminal according to an embodiment of the present invention is described in detail below.

First, the first broadcast data received from the first broadcast channel is reproduced (S500 and interval A in FIG. 6). The controller 120 determines whether switching to the second broadcast channel is desired (S510). If not, the reproduction of the first broadcast channel is continued. If switching channels is desired, then the broadcast data from the first channel is stored in memory 130, and the second broadcast channel is simultaneously reproduced (S520 and interval B in FIG. 6).

Switching to the second broadcast channel or returning to the first broadcast channel may be initiated by a current user action, or it may be initiated by the user programming the controller 130 to switch channels at a specific time.

The controller 130 continually checks to see if a channel change is requested, and if a channel change back to the first broadcast channel is requested (S530), the controller will reproduce the first broadcast data from the memory 130 from the storage initiation time while continuing to store the received broadcast data from the first broadcast channel (S540 and interval C in FIG. 6). As the broadcast data from the first channel is reproduced, that data having been reproduced is deleted from the memory 130 (S550).

The present invention has been described with reference to the above-described embodiments, but the present invention is not limited to those embodiments.

In particular, upon switching from the first broadcast channel to the second broadcast channel, the number of the second broadcast channels may be more than one. For example, a first broadcast channel may be viewed and when a user switches from the first channel to a second channel, the broadcast data from the first channel is stored in memory while the second channel is viewed. If a third broadcast channel is then selected to be viewed, the broadcast data received from the first channel continues to be stored in memory. Then the user switches back to the first channel, the broadcast data of the first channel stored in memory is reproduced while continuously storing the received broadcast data of the first channel.

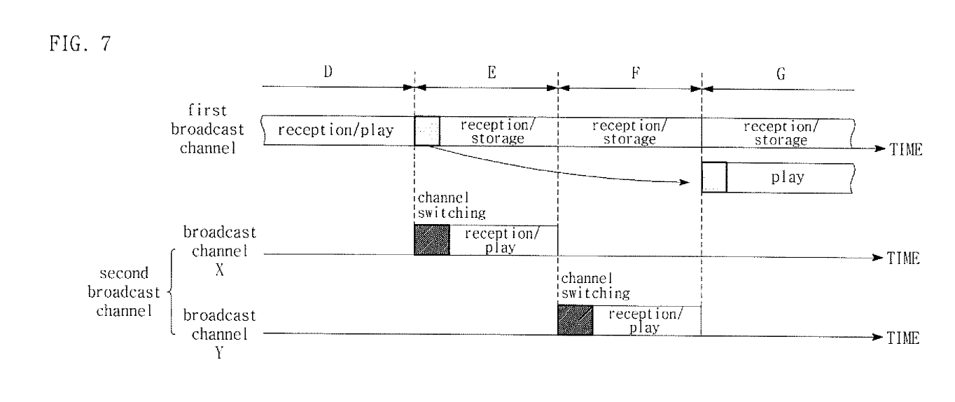

FIG. 7 is illustrates the case of three broadcast channels. In FIG. 7, interval D represents the reception and reproduction of data from a first broadcast channel. Interval E represents the reception and storage of data from first broadcast channel, and the reception and reproduction of data from a second broadcast channel X. Interval F represents the reception and storage of data from the first broadcast channel, and the reception and reproduction of data from a third broadcast channel Y. Interval G shows the reproduction of the stored data from the first broadcast channel stored during intervals E and F, and the continued storing of the received data from the first broadcast channel.

According embodiments of the present invention, the broadcast data of a first channel may be stored in memory while a second broadcast channel is being viewed, and upon returning to the first broadcast channel, the broadcast data stored in memory can be reproduced from a point in time at which the first channel was changed to the second channel with no loss of broadcast data from the first channel.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A method of reproducing broadcast data in a broadcast terminal, the method comprising:
reproducing first broadcast data received from a first broadcast channel;
switching from the first broadcast channel to a second broadcast channel, wherein the second broadcast channel is selected from a plurality of second broadcast channels;
storing the first broadcast data in a storage medium; and
reproducing second broadcast data received from the selected second broadcast channel.

2. The method of claim 1, wherein storing the first broadcast data is started when the switching from the first channel to the selected second channel is started.

3. The method of claim 1, wherein storing the received first broadcast data is started when the switching from the first channel to the selected second channel is completed.

4. The method of claim 1, wherein the received first broadcast data is reproduced until the second broadcast data is reproduced.

5. The method of claim 1, further comprising;
switching from the selected second channel to the first channel; and
reproducing the stored first broadcast data while continuing to store the received first broadcast data.

6. The method of claim 5, wherein reproducing the stored first broadcast data begins at a starting point.

7. The method of claim 6, wherein the starting point corresponds to the time at which the first broadcast data is initially stored.

8. The method of claim 6, wherein the starting point is selected by a user.

9. The method of claim 5, further comprising:
deleting the reproduced stored first broadcast data after reproducing the stored first broadcast data.

10. The method of claim 1, wherein each of the first and second broadcast channels is one of a video channel, an audio channel, and a data channel.

11. The method of claim 1, wherein the first and second broadcast channels are based on different broadcasting standards.

12. A terminal comprising:
a memory for storing broadcast data;
a broadcasting reception module configured to receive broadcast data from a first broadcast channel and a second broadcast channel selected from a plurality of second broadcast channels; and
a controller coupled with the broadcast reception module configured to reproduce the first broadcast data received from a first broadcast channel, to switch from the first broadcast channel to the selected broadcast channel, to store the first broadcast data in a storage medium, and to reproduce second broadcast data received from the selected second broadcast channel.

13. The terminal of claim 12, wherein storing the first broadcast data is started when the switching from the first channel to the selected second channel is started

14. The terminal of claim 12, wherein storing the received first broadcast data is started when the switching from the first channel to the selected second channel is completed.

15. The terminal of claim 12, wherein the controller is configured to reproduce the received first broadcast data until the second broadcast data is reproduced.

16. The terminal of claim 12, wherein the controller is further configured to switch from the selected second channel to the first channel, and to reproduce the stored first broadcast data while continuing to store the received first broadcast data.

17. The terminal of claim 16, wherein reproducing the stored first broadcast data begins at a starting point.

18. The terminal of claim 17, wherein the starting point corresponds to the time at which the first broadcast data is initially stored.

19. The terminal of claim 17, wherein the starting point is selected by a user.

20. The terminal of claim 16, wherein the controller is further configured to delete the reproduced stored first broadcast data after reproducing the stored first broadcast data.

21. The terminal of claim 12, wherein each of the first and second broadcast channels is one of a video channel, an audio channel, and a data channel.

22. The terminal of claim 12, wherein the first and second broadcast channels are based on different broadcasting standards.
